(19) United States
(12) Patent Application Publication
(10) Pub. No.: US 2014/0289624 A1
(43) Pub. Date: Sep. 25, 2014

(54) MULTIMEDIA SYSTEM AND METHOD FOR INTERFACING BETWEEN MULTIMEDIA UNIT AND AUDIO HEAD UNIT

(71) Applicants: Jin Su LIM, Yongin-si (KR); Dong Su EO, Yongin-si (KR)

(72) Inventors: Jin Su LIM, Yongin-si (KR); Dong Su EO, Yongin-si (KR)

(73) Assignee: HYUNDAI MOBIS CO.,LTD., Yongin-si (KR)

(21) Appl. No.: 13/848,886

(22) Filed: Mar. 22, 2013

(51) Int. Cl. G06F 3/16

(52) U.S. Cl. CPC G06F 3/167
USPC 715/716

(57) ABSTRACT

Provided are a multimedia system and a method of interfacing a multimedia unit and an audio head unit. The present invention relates to a method in which an audio front panel of a vehicle is detached from a center fascia of the vehicle to secure a free space, and then, in mounting a multimedia unit in the secured free space, the multimedia unit is operably connected to a pure audio head unit through only a wiring without a separate intermediate medium, such as a trip computer, for manipulating the pure audio head unit of the vehicle, and overcomes limitations of the mounting convenience and manipulability of the multimedia unit.

### TECHNICAL FIELD

The present invention relates to a multimedia system and a method of interfacing a multimedia unit and an audio head unit.

### BACKGROUND

Generally, an information display unit disposed in a front panel of a vehicle audio unit visually displays various pieces of information, associated with an operating state of the audio unit, to a driver. Information provided by the information display unit mainly includes information associated with operating states of a radio and a CD player, but, recently, as various multimedia functions, such as sound reproduction (performed by an MP3 player, a CD player, or an IPod player), a hands free unit using Bluetooth, and voice recognition, are applied to vehicles, combination of displayed information is countlessly diversified. Also, in order for a user to manipulate the various multimedia functions, a plurality of manipulation keys for multi-functions are disposed in the front panel of the vehicle audio system.

For example, when a standard specification vehicle having no expensive option specification needs a navigation unit, a holding scheme is used in which the navigation unit is fixed to an upper end of a dash board and front glass by using a suction plate.

However, such a mounting scheme can be realized at low cost compared to a pure specification, but, the navigation unit obstructs a driver's field of vision in driving. Also, when the navigation unit deviates from the original position due to vehicle vibration, the navigation unit disperses a driver's attention to cause an accident, and moreover, even when other accidents such as a rear-ender occur, there is a possibility that the driver is injured by a contact with the navigation unit or a protrusion portion of a user equipment.

To solve such problems, a built-in type product has been developed in which the existing some elements (attached to a vehicle) such as a vehicle information display unit are removed from the vehicle to secure a free space and a multimedia unit such as a navigation unit is mounted in the free space of the vehicle, but the built-in type needs a scheme in which a function of the removed vehicle information display unit is replaced by a built-in navigation unit.

For this reason, technology was recently developed in which a separate conversion unit replacing the function of the removed vehicle information display unit is prepared and attached to or mounted on the navigation unit side, and thus, various pieces of vehicle information, particularly, pure audio information is provided through a display of the navigation unit.

However, since the separate conversion unit is needed, a configuration of a vehicle becomes complicated, and also, due to a structure in which an audio head unit, conversion unit, and navigation unit of a vehicle are communication-connected to each other, each of the units separately converts information in an operation of exchanging information, in which case the complicated information exchange operation obstructs smooth communication between the audio head unit and the navigation unit.

### SUMMARY

Accordingly, the present invention provides a multimedia system in which, when a multimedia unit is mounted in a space that is secured by detaching an audio front panel from an audio head unit, the multimedia unit is operably connected to a pure audio head unit through only a wiring without a separate intermediate medium, such as a trip computer, for manipulating a pure audio head unit of a vehicle.

The present invention also provides a method of interfacing a multimedia unit and an audio head unit by using the multimedia system.

In one general aspect, a vehicle multimedia system includes: an audio head unit converting vehicle model information and manipulation key information into protocol signals according to a predefined protocol, and outputting the protocol signals, the manipulation key information corresponding to a pure audio function; and a multimedia unit analyzing the protocol signals received from the audio head unit to restore the vehicle model information and the manipulation key information according to the predefined protocol, generating an interface image for manipulating the audio head unit in a touch type on the basis of the vehicle model information and the manipulation key information, and displaying the generated interface image, the multimedia unit being directly connected to the audio head unit through a gender.

In another general aspect, a method of interfacing a multimedia unit and an audio head unit includes: receiving, by the multimedia unit, protocol signals from a pure audio head unit mounted on each of a plurality of vehicles in which the multimedia unit is mounted in a space secured by detaching an audio front panel from a corresponding vehicle, vehicle model information and manipulation key information being converted into the protocol signals according to a predefined protocol; analyzing, by the multimedia unit, the converted protocol signals to restore the vehicle model information and manipulation key information on each vehicle; generating, by the multimedia unit, an interface image for manipulating the pure audio head unit of each vehicle in a touch type on the basis of the restored vehicle model information and manipulation key information on each vehicle, the interface image corresponding to each vehicle; and displaying, when the multimedia unit is mounted on one of the plurality of vehicles, the interface image corresponding to the one vehicle by using a display.

Other features and aspects will be apparent from the following detailed description, the drawings, and the claims.

### BRIEF DESCRIPTION OF THE DRAWINGS

FIG. 1 is a block diagram illustrating a vehicle multimedia system according to an embodiment of the present invention.

FIG. 2 is a detailed block diagram illustrating an internal configuration of each of a vehicle audio head unit and a multimedia unit illustrated in FIG. 1.

FIG. 3 is a flowchart illustrating a method of interfacing the vehicle audio head unit and the multimedia unit according to an embodiment of the present invention.

### DETAILED DESCRIPTION OF EMBODIMENTS

The present invention proposes a method that can facilitate interfacing between a pure audio head unit for vehicles and a multimedia unit which a driver desires to build in or mount on a vehicle.

The present invention relates to a method in which an audio front panel of a vehicle is detached from a center fascia of the vehicle to secure a free space, and then, in mounting a multimedia unit in the secured free space, the multimedia unit is operably connected to a pure audio head unit through only a wiring without a separate intermediate medium, such as a trip computer, for manipulating the pure audio head unit of the vehicle, and overcomes limitations of the mounting convenience and manipulability of the multimedia unit.

Exemplary embodiments of the present invention capable of being easily embodied by those skilled in the art will now be described in detail with reference to the accompanying drawings. The present invention may, however, be embodied in many different forms and should not be construed as being limited to the embodiments set forth herein. In the accompanying drawings, a portion irrelevant to a description of the present invention will be omitted for clarity. Like reference numerals refer to like elements throughout.

In this disclosure below, when it is described that one comprises (or includes or has) some elements, it should be understood that it may comprise (or include or has) only those elements, or it may comprise (or include or have) other elements as well as those elements if there is no specific limitation.

Moreover, each of terms such as “. . . unit”, “. . . part” and “apparatus” described in specification denotes an element for performing at least one function or operation, and may be implemented in hardware, software or the combination of hardware and software.

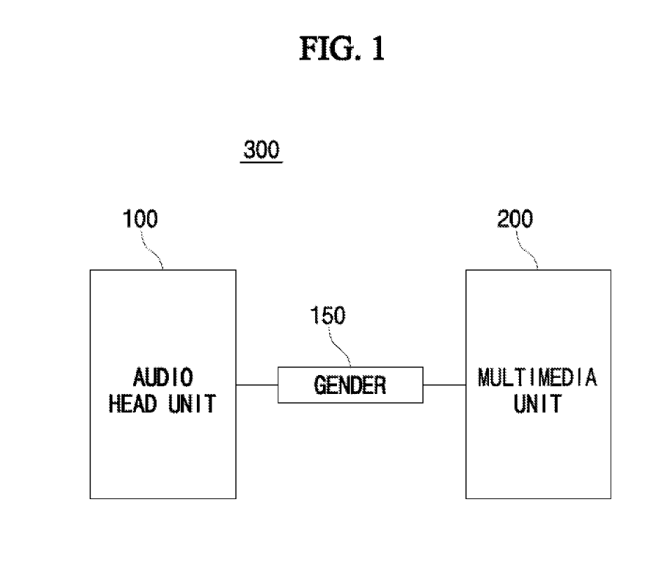

FIG. 1 is a block diagram illustrating a vehicle multimedia system according to an embodiment of the present invention.

Referring to FIG. 1, a vehicle multimedia system 300 according to an embodiment of the present invention includes an audio head unit 100 and a multimedia unit 200 that performs data communication with the audio head unit 100 through a gender 150 (which is a connection means) in an UART communication scheme according to a predefined protocol.

First, the audio head unit 100 converts vehicle model information and manipulation key information, which is set to manipulate a pure audio function corresponding to the vehicle model information, into protocol signals according to the predefined protocol, and outputs the protocol signals.

The multimedia unit 200 receives the vehicle model information and the manipulation key information through the gender 150, generates an interface image for manipulating the audio head unit 100 in a touch type on the basis of the vehicle model information and the manipulation key information, and provides the generated interface image to a driver. Here, unlike a conventional conversion unit, the gender 150 does not perform various data calculation operations for performing a data conversion operation but performs only a simple connection function in order for the two units 100 and 200 to exchange information according to the predefined protocol.

Then, the driver manipulates the interface image in the touch type to manipulate the pure audio function of the vehicle.

In the related art, a conventional audio head unit receives a manipulation command from a conventional multimedia unit through a complicated data conversion operation performed by a separate conversion unit (implemented in hardware) such as a trip computer. However, in the present invention, the audio head unit 100 performs data communication with the multimedia unit 200 according to the predefined protocol, and thus, a function that enables the two units 100 and 200 to analyze and restore data according to a predefined scheme therebetween may be simply implemented in software.

Accordingly, unlike the related art, the present invention does not require the separate conversion unit, and thus, the audio head unit 100 and the multimedia unit 200 can exchange information without a complicated information conversion operation.

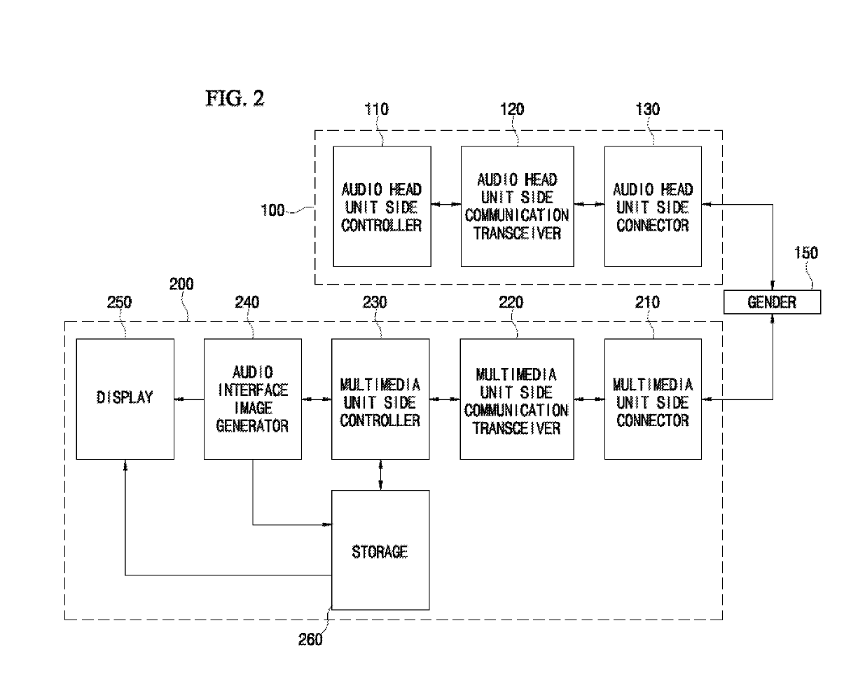

Hereinafter, the multimedia system of FIG. 1 will be described in more detail with reference to FIG. 2.

FIG. 2 is a detailed block diagram illustrating an internal configuration of each of the audio head unit and multimedia unit illustrated in FIG. 1.

Referring to FIG. 2, the audio head unit 100 includes an audio head unit side controller 110, an audio head unit side communication transceiver 120, and an audio head unit side connector 130.

The audio head unit side controller 110 controls an overall operation of the audio head unit 100, and for example, controls pure audio sound quality and a function of receiving a radio signal. Especially, the audio head unit side controller 110 outputs the vehicle model information and the manipulation key information. The vehicle model information and the manipulation key information are previously stored in an internal or external memory of the audio head unit side controller 110, and the audio head unit side controller 110 outputs the vehicle model information and the manipulation key information with reference to the memory in response to a vehicle model information request command transmitted from the multimedia unit 200.

The audio head unit side communication transceiver 120 receives the vehicle model information and the manipulation key information from the audio head unit side controller 110, and converts the vehicle model information and the manipulation key information into protocol signals including a command and a state value which are transmittable in the UART communication scheme according to the predefined protocol.

The audio head unit side connector 130 is physically coupled to the gender 150, and transmits the converted protocol signals to the multimedia unit 200 through the gender 150.

The multimedia unit 200 may be a navigation unit, a PND, a tablet, or the like which is mounted in a free space that is secured by detaching an audio front panel from an audio system which is purely mounted in releasing the vehicle. The multimedia unit 200 may include a multimedia unit side connector 210, a multimedia unit side communication transceiver 220, a multimedia unit side controller 230, an audio interface image generator 240, and a display 250.

The multimedia unit side connector 210 is physically connected to the gender 150, and receives the protocol signals, including the command and the state value, from the audio head unit 100.

The multimedia unit side communication transceiver 220 receives the protocol signals through the connector 210, and analyzes the protocol signals to convert the protocol signals into internal processing-enabled information according to the predefined protocol.

The multimedia unit side controller 230 restores the vehicle model information and the manipulation key information from the converted information, and extracts a plurality of manipulation key items, which are used for manipulating the pure audio function, from the restored vehicle model information and manipulation key information.

The audio interface image generator 240 generates the interface image including a plurality of manipulation key images respectively corresponding to the extracted manipulation key items.

The display 250 is a liquid crystal display (LCD) with a built-in touch panel which converts various pieces of electrical information, generated by various units, into visual information by using light transmittance being changed with applied voltages and transfers the visual information. The display 250 displays the interface image generated by the audio interface image generator 240.

The driver touches the interface image visually displayed by the display unit 250 to manipulate the pure audio function of the vehicle.

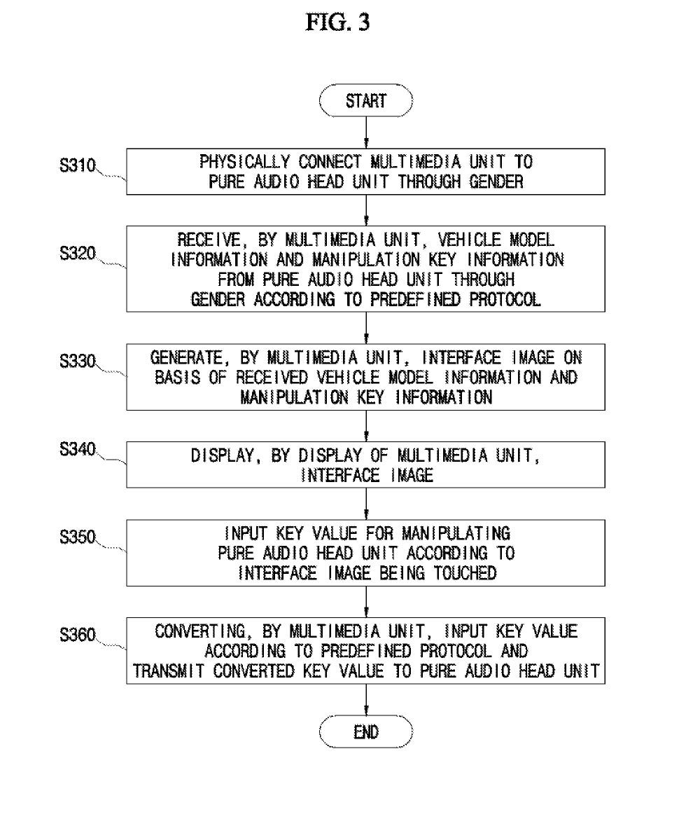

FIG. 3 is a flowchart illustrating a method of interfacing the audio head unit and the multimedia unit according to an embodiment of the present invention.

Referring to FIG. 3, first, a free space is secured by detaching the audio front panel from the center fascia of the vehicle, and the multimedia unit is mounted in the free space. Subsequently, the multimedia unit mounted in the free space is directly connected to the pure audio head unit through the gender in operation S310. As described above, the gender is an element that simply communication-connects the multimedia unit and the pure audio head unit, and does not perform a complicated operation such as data conversion for converting exchanged information into data able to be processed by each of the two units. This being implementable is because each of the multimedia unit and pure audio head unit includes the communication transceiver for performing data communication according to the predefined protocol, a module that analyzes and processes information transferred through the communication transceiver is simply implemented as a software logic, for example, as illustrated in FIG. 2, the elements 110 to 130 of the audio head unit and the elements 210 to 240 of the multimedia unit are integrated into one module implemented as a software logic, and thus, unlike the related art, the multimedia system of the present invention completely performs data conversion even without a separate conversion processing unit implemented in hardware.

Subsequently, when the multimedia unit is physically connected to the pure audio head unit in operation S310, as described above, the pure audio head unit transmits vehicle model information and manipulation key information to the multimedia unit according to the predefined protocol in operation S320.

Subsequently, the multimedia unit generates an interface image corresponding to the transmitted vehicle model information and manipulation key information in operation S330. At this point, a plurality of the interface images may be stored by vehicle-model item in the internal or external storage of the multimedia unit. Specifically, when the multimedia unit is the pure audio head unit capable of data communication according to the predefined protocol, namely, when the multimedia unit may receive vehicle model information and manipulation key information corresponding to the vehicle model information according to the predefined protocol, the multimedia unit generates an interface image for a corresponding vehicle, and stores the generated interface image in a storage in linkage with a corresponding vehicle-model item. Thus, when the multimedia unit is mounted on a different vehicle, the multimedia unit may search the vehicle-model items stored in the storage to select a corresponding vehicle-model item, and reads an interface image corresponding to the vehicle-model item from the storage.

Subsequently, the multimedia unit displays the interface image with the display thereof in operation S340, and receives a key value for manipulating the pure audio head unit according to a user touching a screen of the display in operation S350. Here, operation S340 includes: a step that displays the stored vehicle-model items (vehicle items); and a step in which, when a driver selects a vehicle-model item corresponding to its own vehicle from among the displayed vehicle-model items, the multimedia unit displays an interface image corresponding to the selected vehicle-model item.

Then, the multimedia unit transmits the key value to the pure audio head unit through the gender according to the predefined protocol in operation S306, and the pure audio head unit performs a pure audio function according to the received key value.

According to the present invention, the multimedia unit is operably connected to the pure audio head unit through only the wiring without a separate intermediate medium, such as a trip computer, for manipulating the pure audio head unit, thus maximizing the mounting convenience and manipulability of the multimedia unit in vehicles.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A vehicle multimedia system, comprising:
an audio head unit converting vehicle model information and manipulation key information into protocol signals according to a predefined protocol, and outputting the protocol signals, the manipulation key information corresponding to a pure audio function; and
a multimedia unit analyzing the protocol signals received from the audio head unit to restore the vehicle model information and the manipulation key information according to the predefined protocol, generating an interface image for manipulating the audio head unit in a touch type on the basis of the vehicle model information and the manipulation key information, and displaying the generated interface image, the multimedia unit being directly connected to the audio head unit through a gender.

2. The vehicle multimedia system of claim 1, wherein the multimedia unit comprises:
a controller extracting a plurality of manipulation key items for performing the pure audio function according to the restored vehicle model information and manipulation key information;
an audio interface image generator generating the interface image comprising a plurality of manipulation key images corresponding to the extracted manipulation key items; and
a display visually displaying the generated interface image.

3. The vehicle multimedia system of claim 2, wherein the multimedia unit further comprises a storage storing the interface image generated by the audio interface image generator.

4. The vehicle multimedia system of claim 2, wherein the controller and the audio interface image generator are respectively implemented as software logics, and are mounted on one module.

5. A method of interfacing a multimedia unit and an audio head unit, comprising:
receiving, by the multimedia unit, protocol signals from a pure audio head unit mounted on each of a plurality of vehicles in which the multimedia unit is mounted in a space secured by detaching an audio front panel from a corresponding vehicle, vehicle model information and manipulation key information being converted into the protocol signals according to a predefined protocol;
analyzing, by the multimedia unit, the converted protocol signals to restore the vehicle model information and manipulation key information on each vehicle;
generating, by the multimedia unit, an interface image for manipulating the pure audio head unit of each vehicle in a touch type on the basis of the restored vehicle model information and manipulation key information on each vehicle, the interface image corresponding to each vehicle; and
displaying, when the multimedia unit is mounted on one of the plurality of vehicles, the interface image corresponding to the one vehicle by using a display.

6. The method of claim 5, wherein the generating of an interface image comprises storing a plurality of the interface images by vehicle-model item in a storage of the multimedia unit.

7. The method of claim 6, wherein the displaying of the interface image comprises:
displaying, when the multimedia unit is mounted on one of the plurality of vehicles, a plurality of the vehicle-model items by using the display; and
displaying, by the multimedia unit, when a driver selects a vehicle-model item corresponding to the driver's vehicle from among the displayed vehicle-model items, the interface image corresponding to the selected vehicle-model item.
